(19) United States
(12) Patent Application Publication
(10) Pub. No.: US 2018/0073654 A1
(43) Pub. Date: Mar. 15, 2018

(54) Valve Flow Passage Sleeve

(71) Applicant: Kerr Machine Co., Sulphur, OK (US)

(72) Inventors: Mark S. Nowell, Ardmore, OK (US); Kelcy Jake Foster, Ardmore, OK (US); Michael Cole Thomas, Ardmore, OK (US); Christopher Todd Barnett, Stratford, OK (US)

(21) Appl. No.: 15/702,880

(22) Filed: Sep. 13, 2017

Related U.S. Application Data
(60) Provisional application No. 62/395,015, filed on Sep. 15, 2016.
(60) Provisional application No. 62/395,751, filed on Sep. 16, 2016.

(51) Int. Cl. F16K 27/06

(52) U.S. Cl. CPC F16K 27/065

(57) ABSTRACT

A replaceable sleeve disposed in a flow passage of a plug valve. The sleeve may be press fit or threaded into an annular recess formed in the flow passage. The sleeve may include a groove disposed about a site where the flow passage intersects the internal chamber. The sleeve may be replaced when worn without replacing the entire valve body.

### CROSS REFERENCE TO RELATED APPLICATION

This application claims the benefit of U.S. Provisional Application Ser. No. 62/395,015, filed Sep. 15, 2016, and claims the benefit of U.S. Provisional Application Ser. No. 62/395,751, filed Sep. 16, 2016, the entire contents of which are incorporated herein by reference.

### SUMMARY

The present invention is directed to a valve comprising a body, a plug element, and a sleeve. The body has a flow passage and an internal chamber. The flow passage includes an inlet passage and an outlet passage, and is defined by an internally-disposed wall of the body. The internal chamber intersects the flow passage. The plug element is positioned within the chamber. The plug element is rotatable from a first to a second position. The plug element has a fluid passage extending through it in fluid communication with the flow passage of the body when the rotatable plug element is in the first position. The sleeve is disposed at least partially against the internally-disposed wall of the flow passage.

The present invention is also directed to a valve comprising a body, a rotatable plug element, first and second insert elements, a seal, a first sleeve, and a second sleeve. The body comprises a flow passage and an internal chamber. The flow passage includes an inlet passage and an outlet passage. The internal chamber intersects the flow passage at a first site and has a surface within which an endless groove is formed. The groove surrounds the flow passage at the first site. The plug element is positioned within the chamber and has a fluid passage extending through it. The first and second insert elements are positioned within the chamber and cooperate to at least partially surround the plug element. Each insert element has a fluid opening extending through it. The seal is positioned within the first groove. The first sleeve is disposed within the inlet passage and forms at least a portion of the surface of the internal chamber. The second sleeve is disposed within the outlet passage and forms at least a portion of the surface of the internal chamber.

### BRIEF DESCRIPTION OF THE DRAWINGS

FIG. 1 is a sectional side view of a plug valve having an internal replaceable sleeve formed in its fluid flow passage.

FIG. 2 is a top perspective view of the plug valve of FIG. 1 where the plug and inserts have been removed such that an internally-formed groove can be seen in the valve body.

FIG. 3 is a sectional side view of the plug valve of FIG. 1 with the plug rotated 90 degrees from the view in FIG. 1.

FIG. 4 is a sectional side view of a plug valve having an alternative internal replaceable sleeve formed in its fluid flow passage.

FIG. 5 is a bottom perspective view of two inserts for use in the plug valves of FIGS. 1-4.

FIG. 6 is a bottom view of the two inserts shown in FIG. 5.

FIG. 7 is a partially cut-away perspective view of the plug valve of FIG. 1, with the inserts shown in position within the valve body.

### DETAILED DESCRIPTION

Generally, a plug valve forms a flow passage and has a selectively operable closure to open or close the flow passage in order to control a flow of fluid through the valve. The seal of high pressure valves must withstand high operating fluid pressures. These could be 5,000 pounds per square inch (psi) and higher. In addition, they should do so while controlling the flow of corrosive and/or abrasive fluids. These fluids can erode internal valve components in the oil and gas industry. Valves of this type are often subjected to working pressures of 10,000 psi, 15,000 psi, or more, up to at least 22,500 pounds per square inch. The 5,000 psi number should only be considered a “floor”, below which conditions would not be considered “high pressure” in the hydraulic fracturing and oil and gas industries.

Fluid typically can flow either way through the body when the plug is rotated to the open position. An outer diameter of the plug seals against an inside diameter of each of a number of expandable inserts. In a conventional plug valve an outside diameter of at least some of the inserts has a seal that seals against the bore. Each seal is supported in a groove formed in the outside diameter surface of the inserts. The plug valve body, plug, and insert have through passageways communicating with the bore to allow flow through the valve, such as illustrated by U.S. Pat. No. 2,911,187.

Fluid travelling through the valve is often a fracturing fluid or “frac” fluid. Such fluid is water-based, but includes additives that assist in the fracturing of a downhole formation. These additives may include acids, such as hydrochloric acid. They may also include corrosion or scale inhibitors. Finally, frac fluid often includes suspended “proppants”—often sand or silica—which is used to “prop” open fissures in downhole formations. Such proppants enable additives to reach deeper into formations in oil and gas operations.

Operating a valve at high pressure conditions with acidic fluid containing abrasive proppant material can cause erosion of the location where the seal in the insert contacts the bore, often resulting in leakage. This leakage may occur quickly and limit the life of the valve. Repairing the valve body, such as by a weld build-up and machining operation, is a cumbersome and disruptive repair in the oilfield.

For this reason, it is advantageous to transfer the wear from the valve body to smaller, replaceable parts like the aforementioned inserts. By transferring the seating location of the seal from the insert to the valve body, the wear associated with the seal is moved from the valve body to the insert.

As disclosed in U.S. Patent Publication No. 2017/0089473 in the name of Nowell, et al., the contents of which are hereby incorporated fully by reference, the bore failure point has been eliminated by embedding the seal into a groove formed in the body instead of the inserts. This design transfers the wear to the replaceable inserts and protects the valve body bore sealing surface.

When the wear is transferred from the valve body to the insert, the next wear point may become the inlet and outlet portions of the plug valve. Over time, erosion of these through passageways results in unacceptable wear to the plug valve. As plug valves are starting to last significantly longer because of moving the seal from the insert to the body, this wear point in the through passageways becomes more critical to valve integrity.

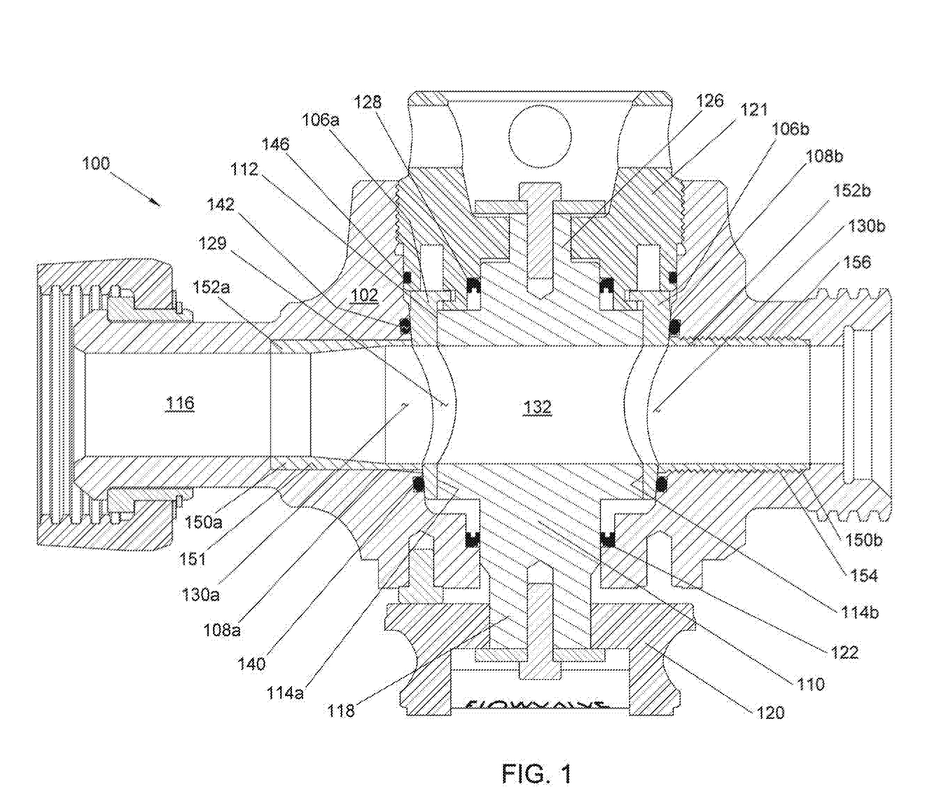

FIGS. 1-3 show a plug valve 100. The plug valve 100 has a forged valve body 102 forming an enlarged internal chamber 104. As shown, the internal chamber 104 is complementary to a tapered cylinder, or conical frustum. However, a cylinder without a taper or one with flat rectangular ends may be utilized for the internal bore. The valve body 102 is a single-piece construction, which will influence the difficulty of machining a groove 142 in the chamber 104.

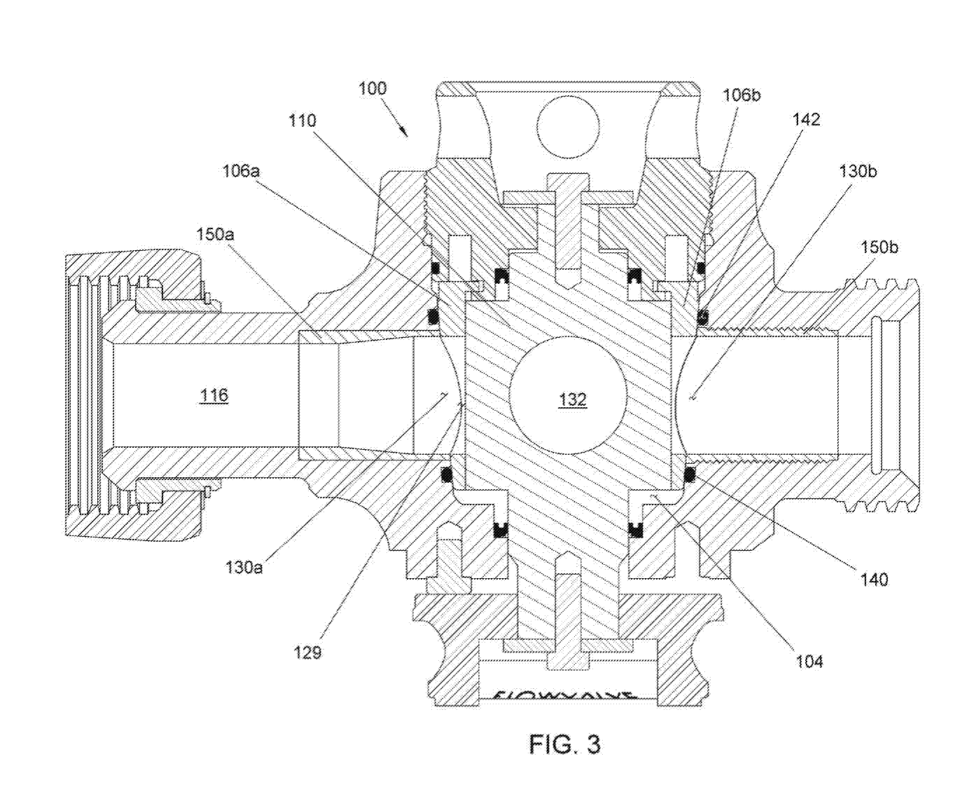

Inserts 106a, 10613 in FIGS. 1 and 3 are segments of an open hollow cone. Although two inserts 106a, 106b are depicted, the contemplated embodiments are not so limited because alternatively there can be more than two. In embodiments with more than two inserts 106a-b, there may be inserts without flow passages. The inserts with flow passages through them may be identically shaped and sized. As shown, each insert 106a, 106b has an outer conical surface 108a, 108b forming a matching taper to engage against the chamber 104 in a close mating relationship. Each insert 106a-b is formed from a body having an inner surface and a spaced outer surface. The outer surface should have a shape complementary to that of the valve chamber. Preferably, the inner surface 114a-b is concave, and the outer surface 108a-b is convex.

A plug 110 has an outer diameter surface 112 sized to fill the space between the inserts 106a-b, mating with an inner diameter surface 114a, 114b of the respective inserts 106. As shown the plug 110 is partially cylindrical, and at least a portion of its outer surface 112 is congruent with a portion of the curved side of a cylinder. The plug 110 has a journal 118 that is rotatable by a handle 120. A packing 122 seals against the journal 118 to contain the pressurized fluid inside the valve 100 while permitting an external force to rotate the journal 118 and, in turn, the plug 110. Alternatively the journal 118 can be rotated by a powered actuator. The plug 110 also has a second journal 126 that rotates within the body 102 and is sealed by packing 128. The inner surface of inserts 106a-b should have a shape complementary to the outer surface 112 of the plug 110.

Inserts 106a-b cooperate with and surround the plug 110. There may be two inserts 106a-b, as shown, or more inserts, where only two of the inserts 106a-b form a flow opening 129 (FIG. 3) extending therethrough. The flow opening 129 interconnects the inner 114a-b and outer 108a-b surfaces of the inserts 106a-b. As shown, no groove or seal is formed on or in the insert 106a-b surrounding the flow opening 129. The inserts 106a-b provide an internal metal-to-metal seal with the rotatable plug 110 while seating against the internal chamber 104. Thus, the inserts 106a-b may have an inner surface having a center of curvature coincident with the axis of rotation of the plug 110. Additionally, each insert 106a-b may have a center of curvature that it does not fully enclose.

The inserts 106a-b and rotatable plug 110 may be made from a durable metallic material, a ceramic material, or high-density plastic. Metallic materials may be the same or a different alloy than used in the valve body 102. Inserts 106a-b and the plug 110 being smaller and more simply formed than the valve body 102, are easier to treat. Inserts 106a-b and plug 110 can therefore be heat treated, treated with chemicals, or made with wear-resistant alloys in order to improve the life of the valve 100.

To enclose the plug no and support the second journal 126, a retaining nut 121 may be threaded to the valve body 102. The retaining nut 121 seals to the valve body chamber 104 by seal 146. The seal 146 may be situated in a groove formed either within the retaining nut 121 or in the valve body 102. Although a radial seal is depicted, in alternative embodiments an axial seal or a crush seal and the like can be used instead of or in addition to the radial seal 146.

The body 102 also defines a fluid flow path 116 intersecting the chamber 104. The fluid flow path 116 has a longitudinal axis normal to the rotational axis of the plug element 110 and the axis of symmetry (if any) of the valve chamber 104. Each insert 106a-b is penetrated by an insert flow opening 129. Each insert 106a-b is mounted within the valve 100 so that the insert openings 129 are aligned with the fluid is flow path 116 and openings 130a-b formed in the valve body 102. The openings 130a-b may be an inlet or an outlet depending on the direction of fluid flow through the valve 100. The plug 110 forms a through-opening 132 permitting a user to selectively align the opening 132 with the openings 129 and 130a-b. FIG. 1 depicts the open position of the valve 100, where the plug 110 is rotated so that the through-opening 132 is aligned with the fluid flow path 116.

In the embodiment shown in the Figures, the chamber 104 and inserts 106a-b are shaped as a tapered cylinder (or, in other words, a conical frustum). Alternately, the chamber may be shaped as a right cylinder, or have a rectangular or square cross-sectional shape. The inserts are shaped to conform to the shape of the chamber.

The body 102 is preferably formed of a high-strength metal material, such as steel. Forged steel provides the durability and strength necessary to operate in high-pressure conditions over 5000 psi. The plug valve 100 may be rated to as much as 10,000 psi, 15,000 psi, or more.

The openings 130a-b are each surrounded by a seal 140 seated in a groove 142. The groove 142 is formed in the wall of the chamber 104 of the valve body 102. Each point along the groove 142 may be spaced a uniform distance from the nearest point on the adjacent opening 130a or 130b. In this configuration, the seal 140 seats on three sides against the groove 142 and on a fourth side against a surface of the corresponding insert 106a-b. Wear, due to interaction between the seal 140 and the surfaces it contacts, is primarily on the insert 106a-b, rather than on the valve body 102. Previous designs, such as that found in U.S. Pat. No. 2,813,695 issued to Stogner, placed a seal in the insert, and caused the wear to be most prevalent on the valve body 102.

The cross-section of the groove 142 is substantially rectangular, with a bottom surface of the groove 142 being parallel to the internally-disposed surface of the chamber 104. The sides of the groove 142 are perpendicular thereto. Alternatively, the sides of the groove 142 may be parallel to the fluid flow path 116. The groove 142 may have a uniform depth. The bottom surface of the groove 142 may be perpendicular to the fluid flow path 116.

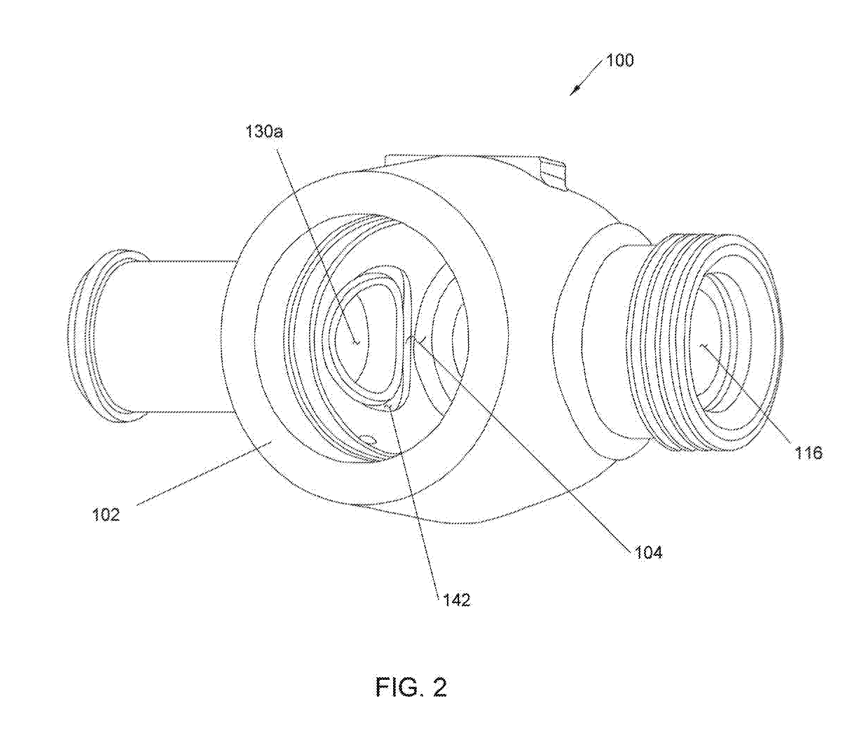

Positioned in this way, the seal 140 (FIG. 1) is evenly distributed about the opening 130a (and opening 130b, not shown in FIG. 2). The seal 140 may be manufactured to fit in the groove 142 or may be a circular seal that is stretched to fit into the groove 142.

Machining such a non-Euclidean groove 142 on the surface of a unitary valve body 102 requires precise and small tools, and is much more difficult than machining a similar shape on an insert 106a-b. However, any difficulty in machining is outweighed by the advantages of transferring wear from the valve body 102 to a replaceable insert 106a-b.

Seals 140 are generally elastomeric rings which may be seated in grooves such as groove 142. Inserts 106a-b, as described above, are metallic pieces which allow the plug 110 to rotate within one or more of the inserts, while complementing the internal chamber 104 of the valve body 102. When the seals 140 mate against the inserts 106a-b, fluid within the flow passage 116 is maintained within the flow passage 116.

With reference now to FIG. 3, the valve 100 is shown with the plug no in a closed position. In the closed position, pressurized fluid within the fluid flow path 116 impacts against the closed plug 110, sealing the plug 110 in a metal-to-metal seal against the insert 106a. The insert 106a is sealed by seal 140 mounted in the groove 142 formed in the valve body chamber 104 (FIG. 2). Thus, in the closed position the pressurized fluid is blocked from flowing through the valve 100. By rotating the plug 110 to the open position as in FIG. 1, its through-opening 132 comes into alignment with the openings 130a-b in the inserts 106a-b, permitting the pressurized fluid to flow through the valve 100 via the fluid flow passage 116.

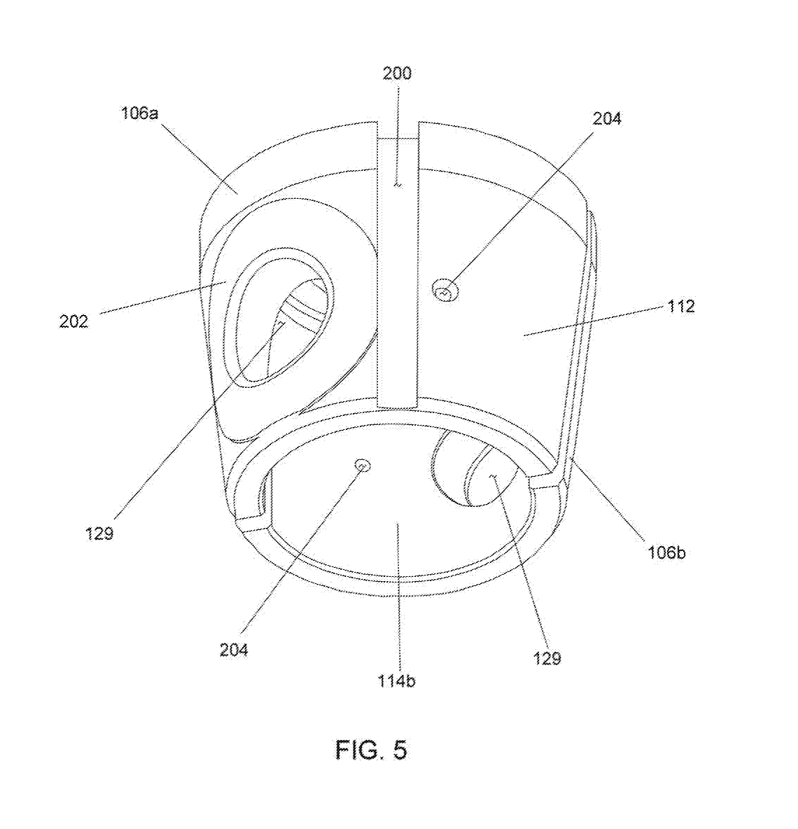

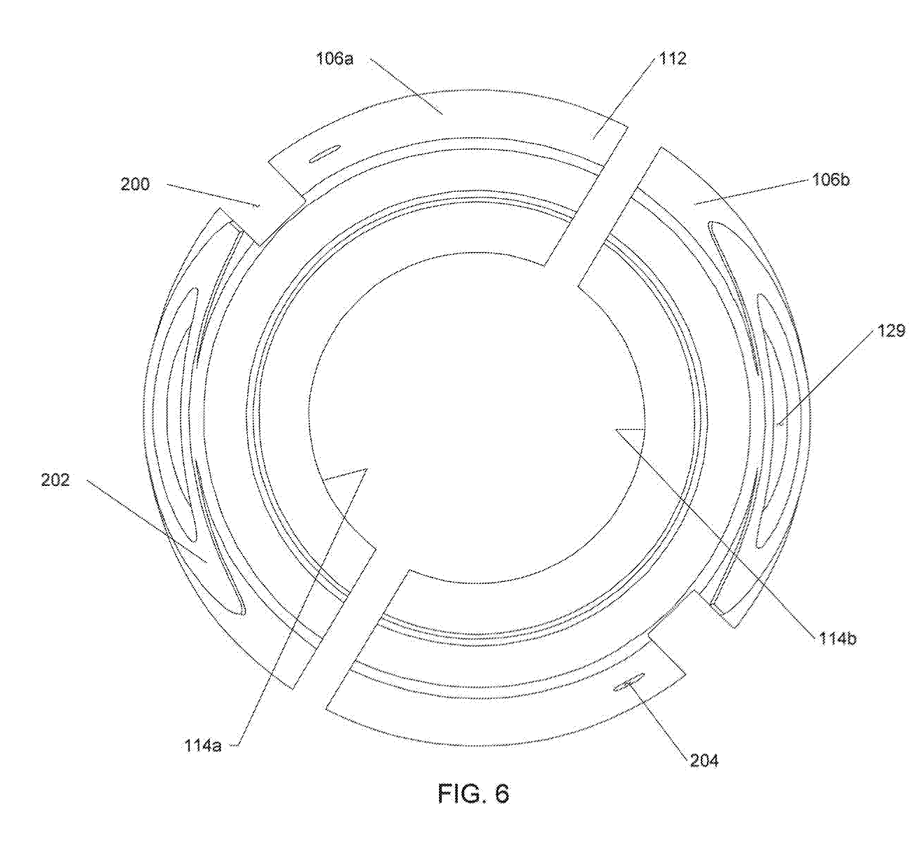

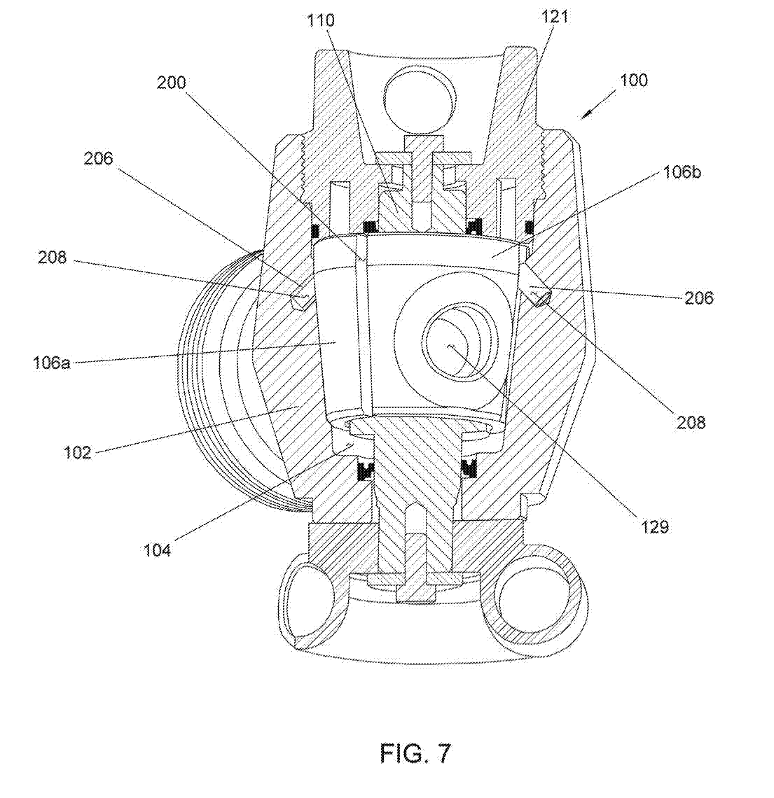

With reference to FIGS. 1, 3, and 5-6, the inserts 106a-b are shown. The inserts 106a-b comprise an external key groove 200 and a raised sealing surface 202. The raised sealing surface 202 provides an interface for the seals 140 (FIGS. 1, 3-5). While a raised surface 202 may be advantageous to proper sealing, it is not strictly necessary. As shown, the sealing surface 202 surrounds each insert opening 129 formed in the inserts 106a-b. As best shown in FIG. 7, the outer surface 112 of the insert 106a-b is a conical frustum, while the interior surfaces 114a-b are complementary to a cylinder.

A small pressure-relief port 204 allows high pressure fluid trapped within the through passage 132 of the plug no (FIG. 3) to release. Such release prevents damage to the valve 100 due to temperature and pressure changes within the closed plug 110.

With reference to FIG. 7, the valve 100 is shown in cross-section with the insert 106a-b shown. A key 206 is formed in a key recess 208 in the valve 100. The key 206 interfaces with the key groove 200 formed in each insert 106a-b. The key 206 prevents the insert 106a-b from rotating within the valve body 102. In FIG. 7, the key recess 208 is shown proximate the retaining nut 121, though the vertical position of the key recess 208 and key 206 is not limiting. As shown, the key 206 is a cylindrical dowel pin, though other constructions may be utilized to prevent rotation of the insert 106a-b.

With reference again to FIGS. 1-3, the valve 100 is shown with a first sleeve 150a in the body 102 proximate the fluid flow path 116. A second sleeve 150b is in the body 102. As shown, the first sleeve 150a is proximate the first opening 103a and the second sleeve 150b is shown proximate the second opening 103b, though this configuration is merely illustrative.

The sleeve 150a, as shown, is press-fit into a corresponding recess 152a is formed in an internally-disposed wall 151 of the body 102. The internally-disposed wall 151 is generally complementary to the flow path 116 or the sleeve 150a, and may be a cylinder or tapered cylinder. The sleeve 150b comprises threads 154. Therefore, the sleeve 150b may be installed into a corresponding second recess 152b formed in an internally-disposed wall 151 of the body 102. The recessed portion 152b of the internally-disposed wall 151 comprises corresponding threads 156 for mating with the threads 154.

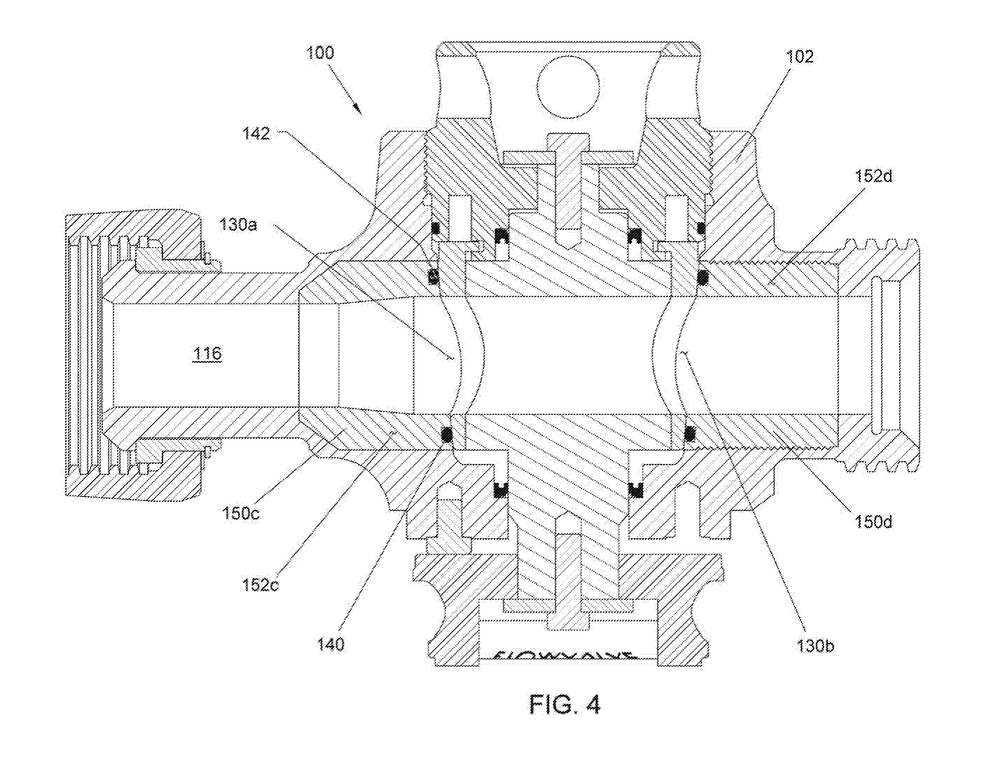

Referring to FIG. 4, alternative sleeves 150c-d are shown within the valve 100. Alternative sleeves 150c-d contain the groove 142 for seating the seals 140. First sleeve 150c is press-fit into recess 152c, while second sleeve 150d is threaded into recess 152d. Thus, wear within the groove 142 due to stress or vibration of the seal 140 will necessitate the replacement of only the sleeves 150c-d, not the valve body 102 itself.

When the grooves 142 are formed in the sleeves 150c-d, the thickness of the sleeves are not limited by the difference between the radius of the grooves and the radius of the openings 130a-b.

The sleeves 150a-d are preferably made of a hardened material. Possible hardened materials may include carburized steel, tungsten carbide, ceramics, stainless steel, or other materials. Using hardened materials improves the life of the sleeves 150a-d and therefore the valve 100. Further, the sleeves 150a-d may be replaced when worn without replacing the valve body 102, further increasing the life of the valve 100.

The sleeves 150a-d may have uniform cross-sectional size and shape. Alternatively, any of the sleeves 150a-d may taper from end to end. In the embodiments of FIGS. 1-4, second sleeves 150b, 150d have inner surfaces complementary to a cylinder. In contrast, first sleeves 150a, 150c taper internally. None of the foregoing shapes for the sleeve is limiting. In general, the surfaces of the sleeves may be machined to match the respective shapes of the recesses 152a-d and flow path 116.

Various modifications can be made in the design and operation of the present invention without departing from the spirit thereof. Thus, while the principle preferred construction and modes of operation of the invention have been explained in what is now considered to represent its best embodiments, which have been illustrated and described, it should be understood that the invention may be practiced otherwise than as specifically illustrated and described.

1. A valve comprising:
a body having;
a flow passage including an inlet section and an outlet section, the flow passage being bounded in part by an internal wall of the body, and an internal chamber intersecting the flow passage;
a rotatable plug element positioned within the chamber and having a fluid passage extending therethrough; and
a first sleeve situated at least partially within the flow passage and in engagement with the wall.

2. The valve of claim 1 wherein the first sleeve and the wall are in threaded engagement.

3. The valve of claim 1 wherein the first sleeve is press fit into the flow passage.

4. The valve of claim 1 wherein the valve has a surface within which an endless first groove is formed, the first groove surrounding the flow passage where the flow passage intersects the internal chamber.

5. The valve of claim 4 wherein the first sleeve and the wall of the internal chamber are smoothly joined.

6. The valve of claim 5 wherein the endless first groove is entirely formed in the first sleeve.

7. The valve of claim 1 wherein the first sleeve is disposed in the inlet section.

8. The valve of claim 7 further comprising a second sleeve at least partially disposed against an internal wall of the outlet section.

9. The valve of claim 8 wherein the first sleeve and the second sleeve each comprise externally-disposed threads.

10. The valve of claim 1 wherein the first sleeve is composed of tungsten carbide.

11. The valve of claim 1 wherein the first sleeve has an inner surface complementary to a cylinder.

12. The valve of claim 1 further comprising first and second insert elements positioned within the chamber and cooperating to at least partially surround the plug element, each insert element having a fluid opening extending therethrough.

13. The valve of claim 12 wherein the internal chamber has a surface within which an endless first groove is formed surrounding a location where the flow passage intersects the internal chamber.

14. The valve of claim 13 further comprising a seal positioned within the first groove.

15. A valve comprising:
a body comprising:
a flow passage including an inlet passage and an outlet passage;
an internal chamber intersecting the flow passage at a first site;
a rotatable plug element positioned within the chamber, having a fluid passage extending therethrough;
first and second insert elements positioned within the chamber and cooperating, to at least partially surround the plug element, each insert element having a fluid opening extending therethrough;
a first sleeve disposed within the inlet passage; and
a second sleeve disposed within the outlet passage;
wherein an endless first groove is formed within the valve and surrounds the flow passage at the first site; and
wherein a seal is positioned within the first groove.

16. The valve of claim 15 wherein the endless first groove is formed in the first sleeve.

17. The valve of claim 15 in which the internal chamber intersects the flow passage at a second site and wherein an endless second groove is formed in the valve and surrounds the flow passage at the second site, further comprising a second seal positioned within the second groove.

18. The valve of claim 17 wherein the endless first groove is formed in the first sleeve and the endless second groove is formed in the second sleeve.

19. The valve of claim 15 wherein the valve defines an annular recess that surrounds the flow passage and joins the internal chamber, and wherein the first sleeve is received in the annular recess.

20. A valve comprising:
a body comprising:
a flow passage including an inlet passage and an outlet passage; and
an internal chamber intersecting the flow passage at a first site;
wherein an endless groove formed in the valve surrounds the flow passage at the first site;
a plug element positioned within the chamber, having a fluid passage extending therethrough;
a first recess disposed within the flow passage which joins the inner chamber at the first site; and
a seal positioned within the first groove.

21. The valve of claim 20 wherein a first sleeve is disposed within the first recess.

22. The valve of claim 21 wherein the first recess and first sleeve comprise mating threads.
